(19) United States
(12) Patent Application Publication
(10) Pub. No.: US 2011/0210611 A1
(43) Pub. Date: Sep. 1, 2011

(54) Novel Solar Power Circuits

(75) Inventors: Anatoli Ledenev, Fort Collins, CO (US); Robert M. Porter, Wellington, CO (US)

(73) Assignee: AMPT, LLC, Fort Collins, CO (US)

(21) Appl. No.: 13/059,955

(22) PCT Filed: Oct. 10, 2008
(86) PCT No.: PCT/US2008/079605

§ 371 Date: Feb. 18, 2011

(51) Int. Cl. H02J 1/10

(52) U.S. Cl. 307/71

(57) ABSTRACT

Particular embodiments of the inventive technology disclosed herein seek to reduce or eliminate the risk of damage to components of photovoltaic power circuits such as solar arrays. Aspects of the inventive technology, in embodiments, utilize diode to prevent reverse current flow in the event of application of a voltage to a power supply string which would otherwise effect such flow. Prevention of such reverse current flow may preclude voltages that would otherwise damage reverse current sensitive devices such as switches that may form part of a voltage limiting DC to DC converter.

### TECHNICAL FIELD

Generally, this inventive technology relates to power circuits. More specifically, aspects of this inventive technology relate to solar (photovoltaic) power circuits, and apparatus and methods that prevent or at least mitigate damage to power circuits that might otherwise occur during circuit operation.

### BACKGROUND ART

Generation of power from alternative sources has received considerably more attention in recent past, due at least in part to the reduced desirability of what may be termed conventional sources such as coal and oil. Whether for cost, pollution, or other reasons, considerably more attention has been recently devoted to power generation from alternate sources such as solar. Although the inventive technology disclosed herein is not limited to electrical power circuits designed specifically as relate to power from alternate sources (e.g., solar), its conception was spurred by the need to improve solar powered circuits in particular.

Generally, electrical power circuits, whether solar or otherwise, have been the focus of many improvements throughout the years. Certain power conversion strategies, which, in solar power circuits, may include operation at MPP (maximum power point), and/or voltage limiting capability, may introduce system vulnerability. One example of such vulnerability is found in the voltage limiting circuit of the converter disclosed in PCT/US2008/057105, where such vulnerability takes the form of reverse current sensitivity. Indeed, a preferred circuit design that achieves the beneficial result of limitation of voltage of serially connected power supplies may exhibit a profound sensitivity to current flow that is in a direction opposite current flow towards positive polarity, such flow urged by the power supply during normal operation (such abnormal flow is termed reverse current). At least one embodiment of the inventive technology has as its primary goal the avoidance of problems, including but not necessarily limited to component or circuit damage that might otherwise occur, in the event of the flow of reverse current and the damaging high voltage that may be associated therewith.

### DISCLOSURE OF INVENTION

In at least one embodiment of the inventive technology, a power circuit 1 may comprise at least two first string power supplies 2 serially connected to define a forward current direction 3, a first power supply string 4, and a first power supply string voltage; at least one voltage limiter 5 established to limit the first power supply string voltage; at least one reverse current inhibitor 6 serially connected with the first string power supplies; and a first string extrinsic power supply 7 that is extrinsic to the first power supply string and that is connected across the first power supply string and the at least one reverse current inhibitor, wherein the first string extrinsic power supply has a first string extrinsic power supply voltage that, at least some point in time during operation of the power circuit, is greater than the first power supply string voltage. Other aspects of the inventive technology are as described herein.

It is goal of at least one embodiment of the inventive technology to preclude circuit or component damage in the event of the flow of reverse current.

It is goal of at least one embodiment of the inventive technology to allow for voltage limitation of solar power supplies in a solar power circuit such as a solar array, and the benefits that result therefrom, while also reducing or eliminating the risk of circuit damage or related problems inherent therein.

It is goal of at least one embodiment of the inventive technology to isolate ground faults/short circuits that may occur in a power supply array (e.g., a solar panel array) having serially connected converters, by preventing the flow of reverse current through the string having such fault or short circuit.

It is a general goal of at least one embodiment of the inventive technology to enable improved performance of solar power circuits.

### BRIEF DESCRIPTION OF DRAWINGS

FIG. 1 shows an embodiment of the inventive technology (one reverse current inhibitor per string).

FIG. 2 shows an embodiment of the inventive technology (one reverse current inhibitor per string).

FIG. 3 shows an embodiment of the inventive technology having two reverse current inhibitors per string in a bipolar array.

FIG. 4 shows an embodiment of the inventive technology having two reverse current inhibitors per string in a bipolar array.

FIG. 5 shows an embodiment of a DC to DC converter with voltage limiting capability that may be used in certain embodiments of the inventive technology.

FIG. 6 shows an embodiment of a DC to DC converter with voltage limiting capability that may be used in certain embodiments of the inventive technology.

FIG. 7 shows an embodiment of the inventive technology.

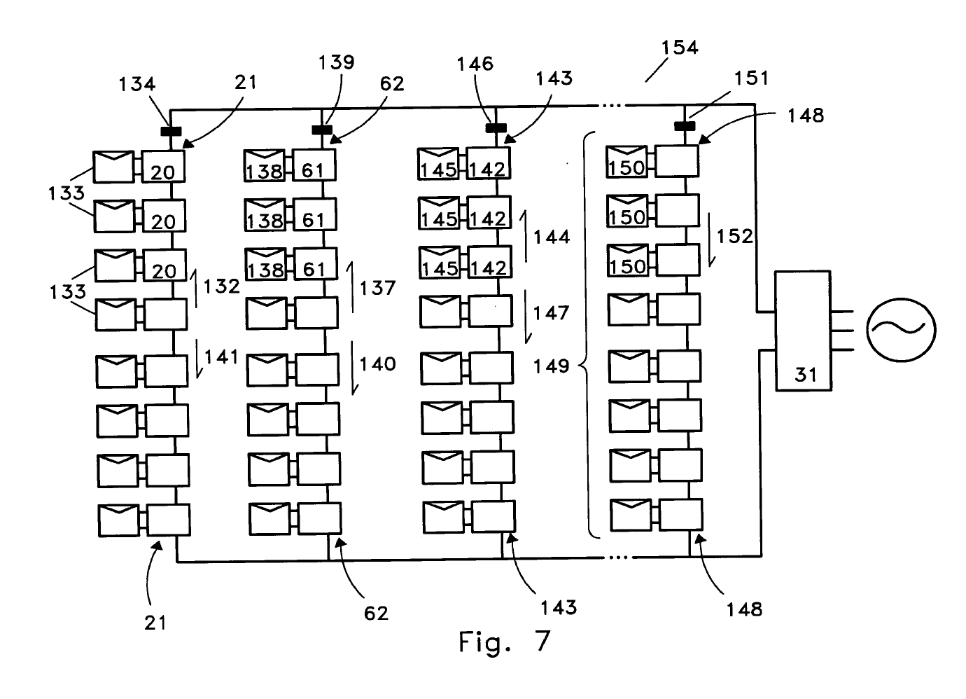

FIG. 8 shows an embodiment of the inventive technology.

FIG. 9 shows how the voltage limit may relate to the maximum power point (which fall on the arc shown in the upper right portion of the figure).

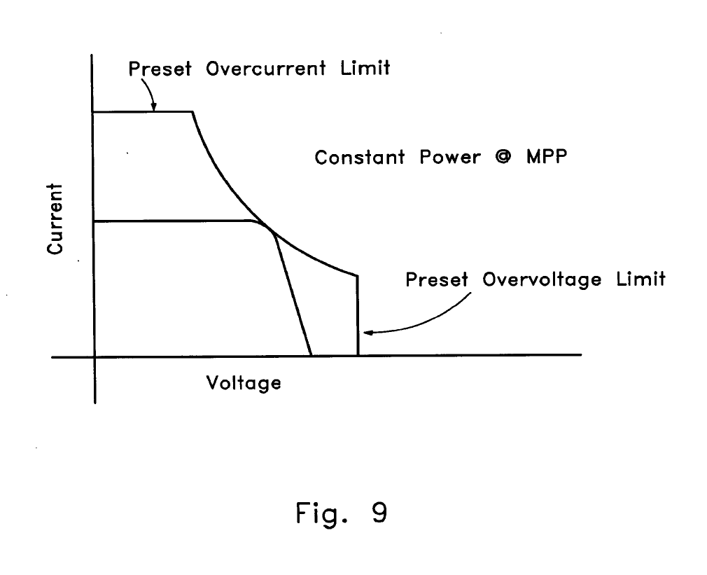

It is of note that, for reasons relative to clarity of presentation in the figures, not all appearances of a certain feature or component (e.g., a first string power supply) in a figure have been called out with a number. Often in the figures, where one part or component is shown in a figure and is called out with a specific number, a discrete part or component that is identical in shape and size, but that is not called out with that number, such designation may have been omitted merely to avoid a “crowded” and difficult to discern figure; often, it may be assumed that the same number may be applied to identically shaped and sized parts and components, within the same figure.

### BEST MODE FOR CARRYING OUT THE INVENTION

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

In at least one embodiment of the inventive technology, a power circuit 1 may comprise at least two first string power supplies 2 serially connected to define a forward current direction 3, a first power supply string 4, and a first power supply string voltage; at least one voltage limiter 5 established to limit the first power supply string voltage; at least one reverse current inhibitor 6 serially connected with the first string power supplies; and a first string extrinsic power supply 7 that is extrinsic to the first power supply string and that is connected across the first power supply string and the at least one reverse current inhibitor, wherein the first string extrinsic power supply has a first string extrinsic power supply voltage that, at least some point in time during operation of the power circuit, is greater than the first power supply string voltage.

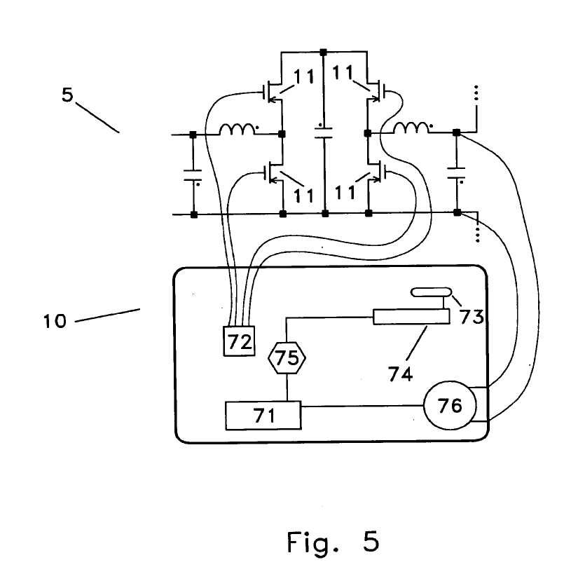

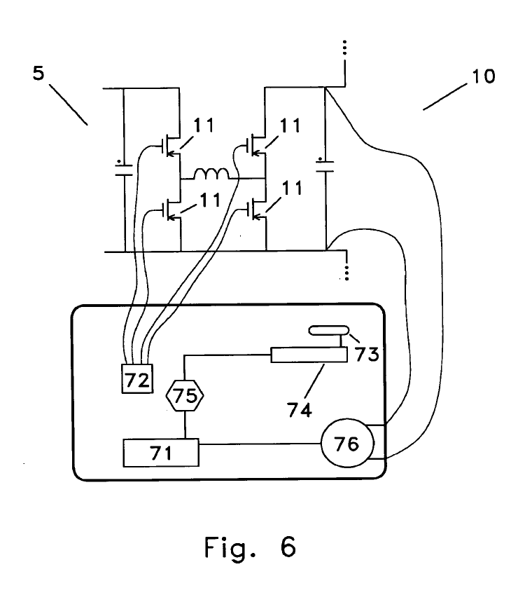

As can be readily understood, where at some point in time during operation of the power circuit, the first string extrinsic power supply voltage is greater than the first power supply string voltage, such relative voltage difference would, without a reverse current inhibitor, cause a reverse current 23 through the at least two first string power supplies 2 (which is said to occur even where the reverse current travels through only a subcomponent of each of such supplies) that causes a voltage that is unacceptably high, such that components are damaged. The reverse current inhibitor is intended to prevent reverse current to the extent necessary to prevent such high voltage, thereby preventing damage or other undesired result to any reverse current sensitive device in the power supply string through which the reverse current is inhibited. In certain cases, particularly where the apparatus comprises a reverse current sensitive device 8—whether such device be a converter 10, a voltage limiter 5 (e.g., a voltage limiting circuit such as a DC to DC converter having voltage limiting capability), and/or a switch 11—and such device is extremely reverse current sensitive (e.g., as in the case of certain switches), the inhibition of current may be outright prevention, and a reverse current preventer such as a diode 12, may be the reverse current inhibitor of choice. A reverse current sensitive device may be reverse current sensitive because of sensitivity to an excessively high voltage (e.g., a damaging voltage) that accompanies or is effected by such reverse current. Switches 11 include, but are not limited to, transistors such as MOSFETS (see, FIGS. 5 and 6) and IGBT's. It is of note that a circuit is considered operating even where only one power supply has a voltage across it, even where there is no current from the circuit (as may be the case where an inverter is not on). As mentioned, the at least one reverse current inhibitor may comprise at least one reverse current preventer, such as (but not limited to) a diode 12.

In at least one embodiment of the inventive technology, a power circuit may comprise at least two first string power supplies 2 serially connected to define a forward current direction 3; at least one reverse current inhibitor 6 established so as to inhibit reverse current through at least one of the at least two first string power supplies 2; and a first string extrinsic power supply 7 that is connected across the at least two first string power supplies and the at least one reverse current inhibitor, where each of the at least two first string power supplies 2 may be output voltage limited (such that voltage output from the power supplies is, at least certain time(s), limited in some fashion, such that it is not greater than a certain value). Of course, each of the at least two first string power supplies may be output voltage limited by a voltage limiter (e.g., a DC to DC converter with voltage limiting capability). Exemplary voltage limiters may be certain of the DC to DC converters as described in PCT/US2008/057105, and shown in FIGS. 5 and 6; such converters may have input terminals (e.g., at their left in FIGS. 5 and 6) connected to a primary power source (e.g., a solar module) and output terminals that connect the voltage limiter in series with other voltage limiters (e.g., at their right in FIGS. 5 and 6).

Often, in certain embodiments, there will not be a connection between the two terminals at the right of the converter of FIGS. 5 and 6. However, in certain embodiments, a bypass diode (which may be parasitic) may be established between such terminals. Such bypass diode, reverse biased during normal operation of the primary power source (e.g., solar module) with which such converter is associated will, during the abnormal condition of an open circuit in the primary power source, allow for forward current flow through the bypass diode, thereby bypassing it, and precluding loss of power from that primary power source and those “up current” from it.

In at least one embodiment of the inventive technology, a power circuit may comprise at least two first string DC to DC converters 20 that are serially connected, that define a first DC to DC converter string 21 and that define a forward current direction 3; a plurality of primary power sources 22, each of which has an output (e.g., a voltage output) that is converted by one of the at least two first string DC to DC converters of the first DC to DC converter string; at least one reverse current inhibitor 6 established so as to inhibit current in a reverse current direction 23 through the at least two first string DC to DC converters of the first DC to DC converter string; and a power supply 24 established across the first DC to DC converter string and the at least one reverse current inhibitor.

It is of note that, as used herein, a power supply is any device or circuit having terminals with a voltage thereacross, includes therein at least one primary power source, and which can supply power at that voltage whether that power is converted (a term that includes voltage conversion, and/or voltage or current limitation) in any fashion or not. It may be a primary power source alone (e.g., a solar module 25 (as is well known, a plurality of connected photovoltaic cells)) or battery, as but two examples, which are essentially without power conversion circuitry), or may be such primary power source and power conversion circuitry that converts the “raw” power harvested from such primary power source—both examples have terminals with a voltage and, as such, are power supplies. Given this broad definition, a string of power supplies may itself be a power supply. When power supplies are connected in such a manner (i.e., in a string, which implies serial connection such that the current through the power supplies is equal, which is in distinct contrast with a parallel connection), they form or define a power supply string (again, which is a type of power supply). A power supply string (or other type of string, such as a converter string), may be termed first or second (or using higher numbered reference nomenclature) merely for reasons relative to clarity of description. Where there is a clear left-most string (e.g., in those apparatus amenable to viewing of the entire apparatus layout from above or from the side), such left-most string is deemed the first string. A first (or other) string extrinsic power supply is merely a power supply that is not within or part of the referenced power supply (in this case, the first string power supply). Often, but not necessarily always, a first (or other) string extrinsic power supply will be connected across the first (or other) string power supply.

It is also of note that a serial connection typically implies that the current through the serially connected devices, components, or circuits (or portions thereof), is equal. Further, when a first device, component or circuit is connected across one or more second device, component or circuit, it is not required that the first device, component or circuit be directly connected with each of the second device(s), component(s) or circuit(s). If some device, circuit or component (a power supply, as but one example) is connected across another device, circuit or component, it is also considered to be connected across any other device, circuit or component between the points of connection

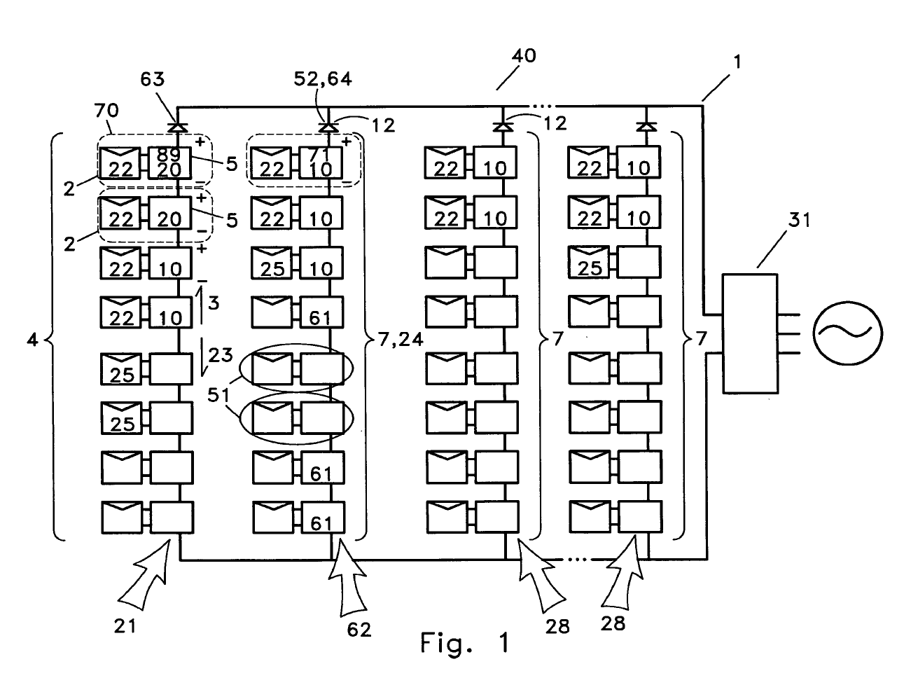

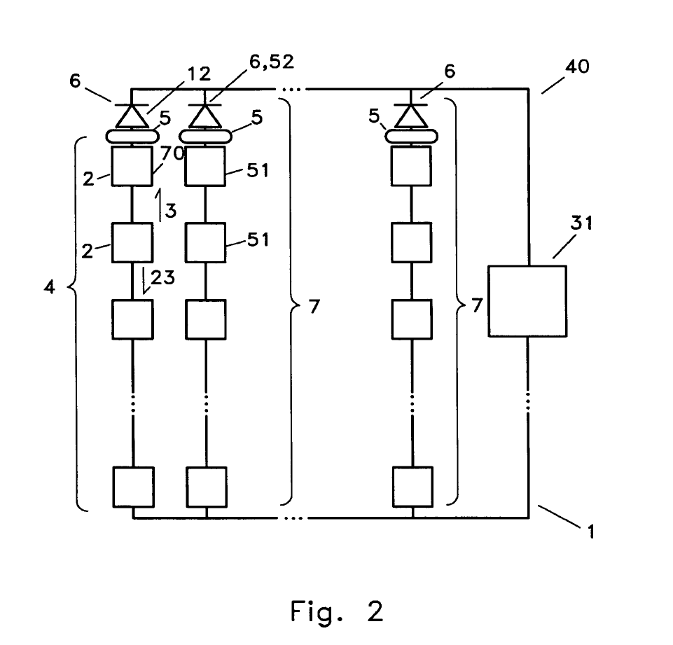

As mentioned, at least one embodiment of the inventive technology may isolate ground faults/short circuits that may occur in a power supply array (e.g., a solar panel array) by preventing the flow of reverse current through the string having such fault or short circuit. A ground fault or short circuit can disable part of a string of power supplies (e.g., solar power supplies), thereby reducing the voltage of such string. Comparatively higher voltages of neighboring strings would tend to cause a reverse current through such low voltage string; the fault or short circuit in such string could result in extraordinarily high currents that could easily case damage to the circuit. A reverse current inhibitor may be established so as to prevent such reverse current and the damage it might cause. Of course, establishing a reverse current inhibitor forward of a forward most established power supply or converter (e.g., at the front of a power supply string or converter string, as shown in FIGS. 2 and 1, respectively), would lessen the risk that a short or fault would take the reverse current inhibitor out of the circuit during a fault, rendering it inoperable. Indeed, certain embodiments of the inventive technology may include a reverse current inhibitor that is established so as to prevent excessive reverse currents through all power supplies or converters of a power supply string or converter string in the event of a fault or short circuit within such string, whether such reverse current inhibitor be the only one in that string, or one of several in that string.

The reverse current inhibitor is any device, circuit or electrical component that inhibits current in a reverse direction (i.e., a direction that is opposite the forward direction defined by a power supply, which may include power supplies that may be strung together); reverse current is inhibited when it is either limited (e.g., so that it does not exceed a certain value), or prevented (i.e., such that it is 0 amps). The reverse current inhibitor, in certain designs, is a diode 12, which, because of its ability to prevent current, may be referred to as a reverse current preventer (when properly oriented, of course).

The voltage limiter 5, whether one per string, one per first string power supply, or fewer (as but a few possible arrangements), is any device, apparatus or circuit that limits voltage, including, but not limited to, a DC to DC converter that has output voltage limiting capability (where voltage output from a certain power supply such as a primary source is limited so as not to exceed a certain value, at least at certain time(s). Even where there is one or more voltage limiter per string power supply (e.g., first string power supply), and it appears that each of the voltage limiter(s) correspond with a specific power supply of such string (and thus appear to limit the voltage of such power supply), such voltage limiter(s) also limit the voltage of the entire string (e.g., the first power supply string voltage) because the voltages of the serially connected power supplies of such strings is the sum of the voltages of such serially connected power supplies (and where one or more values that are later added is first limited, the sum is properly viewed as limited also). In at least one embodiment, it is of related note that where there is one DC to DC converter with voltage limiting capability for each primary power source, voltage from primary power sources may be limited at 50V, there may be eight such converters in each converter string (such that each string, when all voltages are so limited, may produce 400V), and such strings may be connected in parallel, thereby producing a summed current (sum of the current of each of the strings) at 400V that is converted to AC by an inverter and supplied to, e.g., an AC power grid.

A preferred voltage limiter may be a type of DC to DC converter as shown in FIG. 5. The output voltage measured across the output terminals of the converter (e.g., by a type of voltage sensor 76) may then be compared with a voltage setpoint (e.g., 50V as represented by 75) by a control/regulator 71; where the voltage is too high, the duty cycle of the switches may be changed as appropriate by gate drivers 72, thereby lowering the output voltage in a continuous feedback loop. In at least one design, the voltage setpoint may be set remotely by a wireless receiver 73 and microprocessor 74. It is of note that the lower half of FIGS. 5 and 6 are not considered necessary for enablement of this technology (nor even for enablement of the voltage limitation/converter circuit itself). The voltage limit may relate to MPP (maximum power point) as shown in FIG. 10, for example; as the figure shows, the current may also be limited. Additional discussion, certainly not believed critical for enablement of the inventive technology disclosed herein, may be found in PCT/US2008/05710.

In certain of the embodiments having at least one voltage limiter per string, the at least one voltage limiter may comprise at least two voltage limiters, each of which may be established to limit voltage of one of the at least two power supplies of a certain power supply string (e.g., at least two first string power supplies), while still, as explained above, limiting the voltage of the specific power supply string. An example is as shown in FIG. 1, where each DC to DC converter 10 is a voltage limiter.

In particular embodiments, each of the at least two first string power supplies may comprise a converter (e.g., a DC to DC converter), and each of the converters may be a reverse current sensitive device. The converters may be strung together, forming a converter string. Each of the converters may be a voltage limiter; the converter (or voltage limiter) may be reverse current sensitive. In those embodiments with voltage limitation, such limiters may DC to DC converters be as shown in FIGS. 5 and 6, and as further described in PCT/US2008/057105 which is hereby incorporated herein in its entirety. It is of note that the text appearing in PCT/US2008/057105 is not necessary for enablement of such voltage limiting, DC to DC converter; it is incorporated herein merely for those readers interested in a deeper exploration of, e.g., the theoretical basis underlying such converter.

The first power supply string voltage may vary with time; instead, or additionally (as may be the case where the apparatus is a solar array, or part thereof), the first string extrinsic power supply voltage may vary with time. Regardless, at some point in time, the first string extrinsic power supply voltage may be different from the first power supply string voltage. Where it is greater than the first power supply string voltage, it would (without a reverse current inhibitor established to inhibit reverse current through the first power supply string) cause a reverse current to flow through the first power supply string; where it is less than the first power supply string voltage, it would (without a reverse current inhibitor established to inhibit reverse current through the second power supply string) cause a reverse current to flow through the second power supply string. Where either string (or components of such string) includes a reverse current sensitive device (a term that includes, but is not necessarily limited to, electrical circuits and electrical components), such reverse current needs to be inhibited—again, sufficiently limited, or perhaps even prevented—so as to avoid damage or other problems that would occur when reverse current flows through such reverse current sensitive device(s). As is the case with solar arrays, typically each string voltage may be less than one or more neighboring string voltage(s), so each string may ideally include at least one reverse current sensitive device and, as such, each string may need at least one reverse current inhibitor to inhibit (whether limiting or preventing entirely) reverse current through it.

As such, a reverse current inhibitor may comprise at least one reverse current preventer, such as a diode 12. One or more of the power supply strings may comprise a converter string 28 (e.g., the first power supply string may have a first converter string 21, the second power supply string may have a second converter string, etc.), while the first string extrinsic power supply 7 may be voltage limited (as may indeed also be the second string extrinsic power supply, a third string extrinsic power supply, etc.).

As mentioned, the at least two first string power supplies may each comprise a primary power source which, in at least one embodiment, is a solar module. Indeed, the apparatus may relate to an entire power supply array 40 (e.g., solar module array), which may be a series of identical (or nearly so) strings (e.g., third, fourth, up to n^{th} power supplies or power supply strings) that are connected in parallel (with other strings and/or other power supplies). An array includes all components, such as modules, converters, reverse current inhibitors, wiring, communication, electronics, inverter, framing, structure, etc., and not simply the modules themselves. In certain embodiments, such additional strings may be referred to as additional power supplies that are connected in parallel with, e.g., strings (e.g., power supply strings, converter strings), at least two first string power supplies and said first string extrinsic power supply. Where appropriate, if the power generated by such parallel strings needs to be in AC (and is not at that point), an inverter 31 may then invert the power from DC to AC form so that it may be delivered to, e.g., an AC power grid.

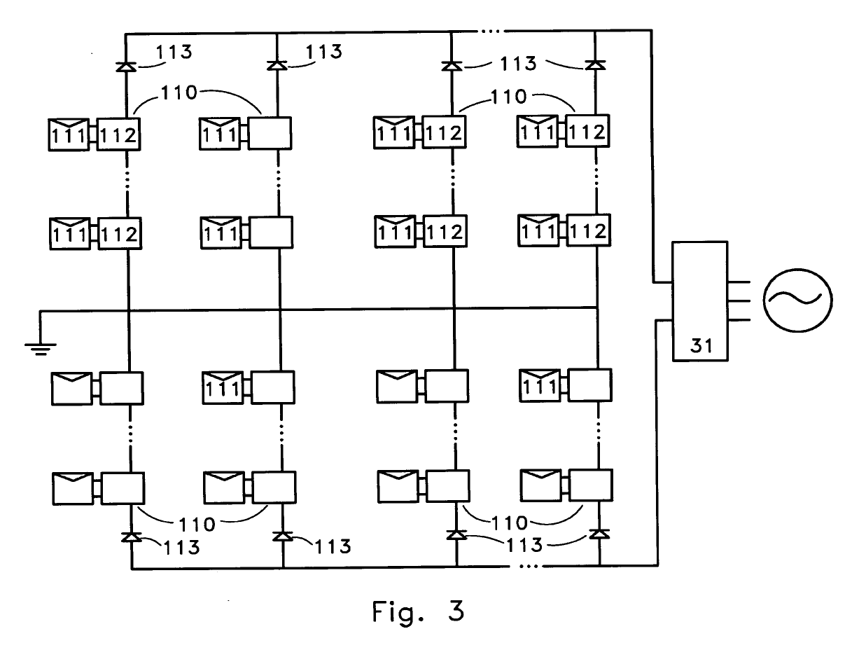

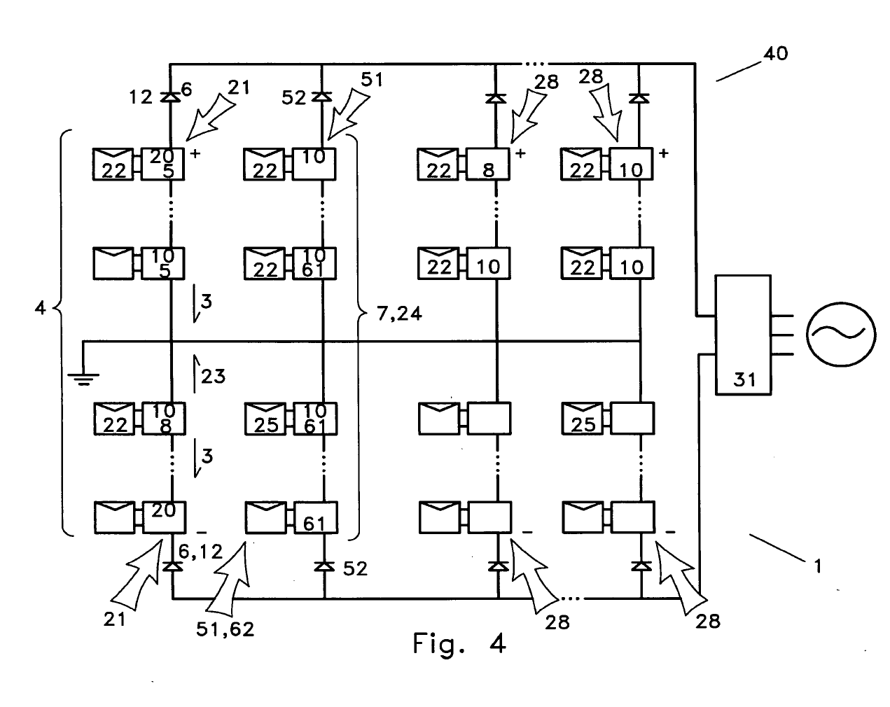

In particular embodiments, the at least one reverse current inhibitor (e.g., per string) is only one reverse current inhibitor (see, e.g., FIG. 1); such single inhibitor may be serially connected anywhere in the string or serially connected to the string so as to inhibit reverse current through such string. For example, it may be established forward of a forward most established power supply of a specific power supply string (e.g., a forward most established first string power supply, or a forward most established second string power supply as shown in FIGS. 1 and 2). Indeed, although this may be a preferred design in certain applications (due to the aforementioned benefits in the event of a ground fault or short circuit in a string), in other applications it may be preferable to place the single reverse current inhibitor for a specific string in an alternate location; still other designs may benefit from one the use of two reverse current inhibitors for each power supply string (see discussion below, and FIGS. 3 and 4 relative to bipolar solar arrays). Note that where the at least one reverse current inhibitor is only one reverse current inhibitor, the context of the description (e.g., as found in the claims) in which such qualifying text appears would typically allow for more than one inhibitor in the entire array (as the context typically would mean only one reverse current inhibitor per string, and an array is typically a plurality of strings connected in parallel).

In certain embodiments, the first string extrinsic power supply may comprise a string of second string power supplies 51 that define a second power supply string; as mentioned, the second power supply string may comprise a second converter string, and the first power supply string may itself comprise a converter string. Typically, but not necessarily always, there may be one converter per power supply in a string.

In certain embodiments, the at least one reverse current inhibitor may be at least one first, reverse current inhibitor (e.g., where it is established so as to inhibit reverse current through; perhaps it is serially connected to, or is part of, the first power supply string. The power circuit may further comprise at least one second, reverse current inhibitor 52 established so as to inhibit reverse current through the second power supply string. The at least one first, reverse current inhibitor may be one (meaning there is only one for such string) first reverse current inhibitor (one associated with the first string and providing all the reverse current inhibition experienced by that string), and the only one first, reverse current inhibitor may be serially connected forward of a forward most established first string power supply 70 of the first power supply string (as but one exemplary configuration as shown in FIGS. 1 and 2). Further, the at least one second, reverse current inhibitor may be one second reverse current inhibitor (one associated with the second string and providing all the reverse current inhibition experienced by that string), and the only one second, reverse current inhibitor may be serially connected forward of a forward most established second string power supply of the second power supply string (as but one design, as may be shown in FIGS. 1 and 2). Indeed, as with other power supply strings, although this may be a preferred design in certain applications, in other applications it may be preferable to place the single reverse current inhibitor for that string in an alternate location; still other designs may benefit from the use of more than one reverse current inhibitor for each power supply string (e.g., two per string, as in the case of bipolar solar arrays).

In certain embodiments, there may be at least one reverse current sensitive device in each of the at least two first string power supplies; such at least one reverse current sensitive device may be a converter 10. The converter may be an output voltage limiter 5 (because it may limit voltage output by a power supply such as a primary power source so that such voltage, at least certain time(s), does not exceed a certain value), and may include a switch 11 that is reverse current sensitive.

In particular embodiments, and as mentioned above, each of the at least two first (or second, or higher numbered) string power supplies may comprise a converter, each of which may be a reverse current sensitive device. In embodiments where the converter(s) is an output voltage limiter, such output voltage limiter may comprise at least one switch that is reverse current sensitive. The switch may appear in a voltage limiting circuit (a type of voltage limiter) as shown in FIGS. 5 and 6.

In embodiments with a converter string(s), each of the at least two first string DC to DC converters may be voltage limiters. Indeed, if a converter can limit voltage where necessary or required under a certain protocol or design strategy, that converter can be referred to as a voltage limiter. Of course, the converter might have such capability at all times (e.g., in a continuously operating feedback loop), but such limitation might be necessary at only certain times. And, perhaps needless to say, even where a converter also performs another function (e.g., harvests power from solar modules at MPP, as is often the case), it may still be deemed a voltage limiter. Also, each of the at least two first string DC to DC converters may be reverse current sensitive, perhaps (as but one possible reason) because of a switch 11 that the voltage limiters may comprise.

It is of note that in certain embodiments where a power supply is established across the first converter (e.g., DC to DC converter) string and the at least one reverse current inhibitor, such power supply may comprise at least two second string DC to DC converters 61 that are serially connected and that define a second DC to DC converter string 62. The at least one reverse current inhibitor (established so as to inhibit current in a reverse current direction through the first string converters) may be at least one first reverse current inhibitor 63 established so as to inhibit current in a first reverse current direction (“first” because such reverse current direction is associated with the first converter string), and the power circuit may further comprise at least one second reverse current inhibitor 64 established so as to inhibit current in a second reverse current direction (“second” because such reverse current direction is associated with the second converter string) through the at least two second string DC to DC converters 61 of the second DC to DC converter string 62. The at least one second reverse current inhibitor may be one second reverse current inhibitor (see, e.g., FIG. 1), one of the at least two second string DC to DC converters may be a forward most established second string DC to DC converter 71, and the one second reverse current inhibitor may be established forward of the forward most established second string DC to DC converter, just as a first reverse inhibitor may be established forward of a forward most established first string DC to DC converter 89. It is also of note that the at least two second string DC to DC converters may be reverse current sensitive—perhaps because they contain a reverse current sensitive voltage limiter, which itself may be reverse current sensitive because of a certain switch(es) it may comprise. In relevant manner, a voltage limited power source (a power source whose output voltage is limited) may act like an ideal voltage source (very small or negligible internal resistance). As such, even small voltage differences between strings of power supplies connected in parallel may cause large reverse current to flow in the lower voltage string.

In particular embodiments with primary power sources and a power supply established across the first DC to DC converter string and the at least one reverse current inhibitor (see, e.g., FIG. 1), the primary power sources may be first, primary power sources (e.g., because of their affiliation with a first converter string or first power supply string) and the power supply established across the first DC to DC converter string and the at least one reverse current inhibitor may comprises at least two second, primary power sources (because of their affiliation with the second converter string or second string power supply). Of course, in any embodiment with power supplies, each may comprise a primary power source, such as a solar module. Particularly in such embodiments, the power circuit may be a solar array circuit.

It is of note that, as shown in FIGS. 3 and 4, embodiments of the inventive technology may relate to what is referred to as a bipolar array, in which voltage strings having both positive and negative outputs relative to a ground or neutral potential are connected in parallel. A bipolar array may benefit from two reverse current inhibitors per string; one would prevent reverse current through the negative output portion (see the string portions below the horizontal grounding wire of FIGS. 3 and 4) of the string and the other would prevent reverse current through the positive output portion (see the string portions above the horizontal grounding wire of FIGS. 3 and 4). As such, in particular embodiments of the inventive technology, particularly those relating to a bipolar array (see FIGS. 3 and 4), there may be only two reverse current inhibitors for a (i.e., associated with a) converter string or power supply string. In embodiments with at least one reverse current inhibitor for a string, such may be only two reverse current inhibitors for such sting (e.g., converter string or power supply string). More particularly, in certain embodiments, one of such reverse current inhibitors established to inhibit reverse current through a first (or other) string may be established forward of a forward most first string power supply (or forward of a forward most first, or other, string converter) while the other may be established rearward of a rearward most established first (or other) string power supply (or rearward of a rearward most first, or other, string converter). Indeed, in any embodiment of the inventive technology, any strings may exhibit an arrangement of component or connected parts that mimics those of other strings. As such, strings other than the first string may have an arrangement of component or connected parts that is identical or at least substantially similar to that of the first string. Features indicated as applying to one string (e.g., a first converter string) may be found in other strings. Such a repetitive style of design is frequently seen in, e.g., solar arrays.

A powering method may comprise the steps of: serially connecting at least two first string power supplies to define a forward current direction and a first power supply string, and to have a first power supply string voltage; limiting the first power supply string voltage (e.g., with a converter with voltage limiting capability); serially connecting at least one reverse current inhibitor with the at least two first string power supplies; and connecting a first string extrinsic power supply across the first power supply string and the at least one reverse current inhibitor, wherein the first string extrinsic power supply has a first string extrinsic power supply voltage that, at least some point in time during operation of the power circuit, is greater than the first power supply string voltage. Dependent features may be as described elsewhere in this specification, and in the claims, all of which are herein incorporated into this description.

A powering method may comprise the steps of: serially connecting at least two first string power supplies to define a forward current direction and a first power supply string; establishing at least one reverse current inhibitor so as to inhibit reverse current through at least one of the at least two first string power supplies; and connecting a first string extrinsic power supply across the first power supply string and the at least one reverse current inhibitor, wherein each of the at least two first string power supplies is output voltage limited. Dependent features may be as described elsewhere in this specification.

A powering method may comprise the steps of: serially connecting at least two first string DC to DC converters to define a first DC to DC converter string and a forward current direction; converting, with one of the at least two first string DC to DC converters of the first DC to DC converter string, output from each of a plurality of primary power sources; establishing at least one reverse current inhibitor so as to inhibit current in a reverse current direction through the at least two first string DC to DC converters of the first DC to DC converter string; and establishing a power supply established across the first DC to DC converter string and the at least one reverse current inhibitor. Dependent features may be as described elsewhere in this specification.

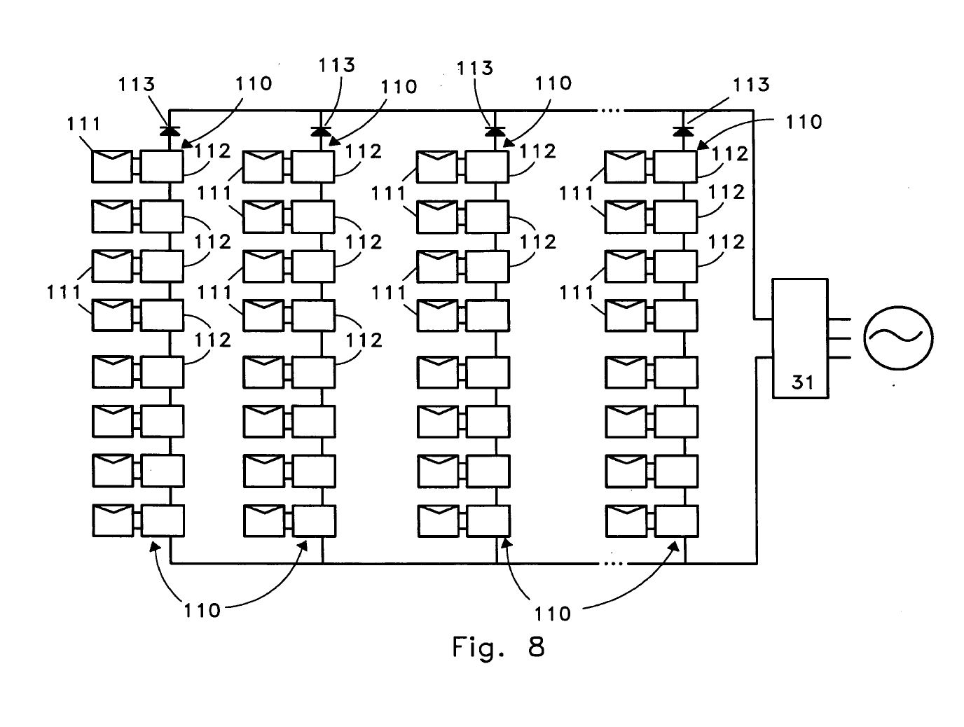

An additional description of the inventive technology, perhaps a bit more detailed than certain other independent aspects, may be a power circuit that comprises: at least two first string DC to DC converters 20 that are serially connected, that define a first DC to DC converter string 21, and that define a first forward current direction 132 (first because of its relevance to the first converter string); a plurality of first converter string converted, solar modules 133 (nominated as such because these solar modules have an output that is converted by the converters of the first converter string), each of which has an output voltage that is limited by one of the at least two first string DC to DC converters of the first DC to DC converter string; at least one first string reverse current inhibitor 134 (e.g., a reverse current preventer such as a diode) established so as to inhibit current in a reverse current direction 141 (which is opposite the first forward current direction)) through the at least two first string DC to DC converters of the first DC to DC converter string; at least two second string DC to DC converters 61 that are serially connected, that define a second DC to DC converter string 62 that is connected in parallel with the first DC to DC converter string, and that define a second forward current direction 137; a plurality of second converter string converted, solar modules 138, each of which has an output voltage that is limited by one of the at least two second string DC to DC converters of the second DC to DC converter string; at least one second string reverse current inhibitor 139 established so as to inhibit current in a reverse current direction 140 through the at least two second string DC to DC converters of the second DC to DC converter string; at least two third string DC to DC converters 142 that are serially connected, that define a third DC to DC converter string 143 that is connected in parallel with the first and the second DC to DC converter string, and that define a third forward current direction 144; a plurality of third converter string converted, solar modules 145, each of which has an output voltage that is limited by one of the at least two third string DC to DC converters of the third DC to DC converter string; at least one third string reverse current inhibitor 146 established so as to inhibit current in a reverse current direction 147 through the at least two third string DC to DC converters of the third DC to DC converter string; at least one additional (i.e., other than the first, second or third) DC to DC converter string 148 that is connected in parallel with the first, second and third DC to DC converter strings; at least one additional group of solar modules 149 (i.e., other than those associated with the first, second and third converter strings), each additional group having solar modules 150 whose output voltage is limited by one of the DC to DC converters of one of the at least one additional DC to DC converter string; at least one additional string reverse current inhibitor 151 established so as to inhibit current in a reverse current direction 152 through the DC to DC converters of the at least one additional DC to DC converter string; and an inverter 31 that converts DC power from the parallely established converter strings into AC power, wherein the DC to DC converter strings, the solar modules, the reverse current inhibitors and the inverter define a solar array 154. In particular embodiments, the at least one reverse current inhibitor associated with each of the DC to DC converter strings is one reverse current inhibitor associated with each of the DC to DC converter strings (see FIG. 8, as but one example). All dependent features not included in the description in this paragraph, but appearing in either the written description or the drawings or the claims are, of course, possible dependent features of this specific aspect of the inventive technology. For example, the first converter string converted, solar modules might, like any other primary power sources in any of the other embodiments disclosed anywhere in this specification, not be serially connected.

At least one aspect of the inventive technology may be described as a series of DC to DC converter strings 110 that are connected in parallel, a plurality of primary power sources 111 (e.g., solar modules), each of which is connected with one (e.g., a different one) of the converters 112 of the converter string, a plurality of reverse current inhibitors 113 (e.g., diodes), each of which is connected serially with one of the converter strings, such that each string has one or more of the reverse current inhibitors connected connected serially therewith. The converters may, in at least one embodiment, each have voltage limiting capability. The power circuit may further include an inverter 31 that converts DC power from the parallel converter strings in to AC power. Of course, as in other embodiments, the circuit may be a solar array. It is of note that each of the inhibitors can be connected serially with one of the converter strings such that each string has one or more of the reverse current inhibitors connected serially therewith not only when the inhibitor(s) is/are connected at an end (e.g., a forward end and/or a rear end), but also where it is embedded within a string (such that it is between converters of a converter string).

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “power circuit” should be understood to encompass disclosure of the act of “powering”—whether explicitly discussed or not—and, conversely, were there effectively disclosure of the act of “powering”, such a disclosure should be understood to encompass disclosure of a “power circuit” and even a “means for powering” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### LIST OF REFERENCES

I. U.S. Patent Documents

| DOCUMENT NO. | PUB'N | |
|---|---|---|
| & KIND CODE (if | DATE | PATENTEE OR |
| known) | mm-dd-yyyy | APPLICANT NAME |
| 4,127,797 | 11-28-1978 | Perper |
| 4,375,662 | 03-01-1983 | Baker |
| 4,390,940 | 06-28-1983 | Corbefin et al. |
| 4,404,472 | 09-13-1983 | Steigerwald |
| 4,445,049 | 04-24-1984 | Steigerwald |
| 4,626,983 | 12-02-1986 | Harada et al. |
| 4,725,740 | 02-16-1988 | Nakata |
| 5,027,051 | 06-25-1991 | Lafferty |
| 5,648,731 | 07-15-1997 | Decker et al. |
| 5,747,967 | 05-05-1998 | Muljadi et al. |
| 6,081,104 | 06-27-2000 | Kern |
| 6,281,485 | 08-28-2001 | Siri |
| 6,282,104 | 08-28-2001 | Kern |
| 6,351,400 | 02-26-2002 | Lumsden |
| 6,369,462 | 04-09-2002 | Siri |
| 6,448,489 | 09-10-2002 | Kimura et al. |
| 6,791,024 | 09-14-2004 | Toyomura |
| 6,889,122 | 05-03-2005 | Perez |
| 6,914,418 | 07-05-2005 | Sung |
| 7,091,707 | 08-15-2006 | Cutler |
| 7,158,395 | 01-02-2007 | Deng et al. |
| 7,227,278 | 06-05-2007 | Realmuto et al. |
| 7,274,975 | 09-25-2007 | Miller |
| 20050002214A1 | 01/06/2005 | Deng et al. |
| 20050068012A1 | 03/31/2005 | Cutler |
| 20050162018A1 | 07/28/2005 | Realmuto et al. |
| 20060103360A9 | 05/18/2006 | Cutler |
| 20060174939A1 | 08/10/2006 | Matan |
| 20070035975A1 | 02/15/2007 | Dickerson et al. |
| 20010007522 A1 | 07-12-2001 | Nakagawa et al. |
| 20030111103 A1 | 06-19-2003 | Bower et al. |
| 20070069520 A1 | 03-29-2007 | Schetters |
| 20070133241 A1 | 06-14-2007 | Mumtaz et al. |

II. Foreign Patent Documents

| Foreign Patent | PUB'N | PATENTEE OR APPLICANT |
|---|---|---|
| Document | DATE | NAME |
| WO 2004100344 A2 | 11/18/2004 | Ballard Power Systems |
| | | Corporation |
| WO 2004100348 A1 | 11-18-2004 | Encesys Limited |
| WO 2005027300 A1 | 03/24/2005 | Solarit AB |
| WO 2005036725 A1 | 04-21-2005 | Konin-Klijke Philips Electronics |
| WO 2006005125 A1 | 01/19/2006 | Central Queensland University |
| | | et al. |
| WO 2006071436 A2 | 07/06/2006 | ISG Technologies, LLC |
| WO 2006013600 A2 | 02/09/2006 | Universita Degli Studi DiRoma |
| | | “La Sapienza” |
| WO 2006013600 A3 | 02/09/2006 | Universita Degli Studi DiRoma |
| | | “La Sapienza” |
| WO 2006048688 A1 | 05-11-2006 | Encesys Limited |
| WO 2006048689 A2 | 05-11-2006 | Encesys Limited |
| WO 2006048689 A3 | 05-11-2006 | Encesys Limited |
| WO 2006137948 A2 | 12/28/2006 | ISG Technologies, LLC |
| WO 2007007360 A2 | 01/18/2007 | Universita Degli Studi Di Salerno |
| WO 2007080429 A2 | 07-19-2007 | Encesys Limited |
| JP 62154121A | 09/07/1987 | Kyogera Corp |
| EP 0964415 A1 | 12/15/1999 | Igarashi, Katsuhiko-TDK Corp |
| EP 0780750 B1 | 03/27/2002 | Nakata, et al. |
| EP 1120895 A3 | 05/06/2004 | Murata Manufacturing Co, et al. |
| GB 2434490 A | 07/25/2007 | Enecsys Limited, et al. |
| GB 2421847 A | 07/05/2006 | Enecsys Limited, et al. |
| GB 2419968 A | 05/10/2006 | Enecsys Limited, et al. |
| GB 2415841 A | 01/04/2006 | Enecsys Limited, et al. |
| FR 612859 | 11/18/1948 | Standard Telephones and Cables |
| | | Limited |
| DE 310362 | 09/26/1929 | Rheinishce Metallwaaren-Und |
| | | Maschinenfabrik |
| | | Sommerda Aktien-Gesellschaft |
| JP 2002231578 A | 08/16/2002 | Meidensha Corp |
| JP 2000020150 A | 01/21/2000 | Toshiba Fa Syst Eng Corp. et al. |
| JP 08066050 A | 03/08/1996 | Hitachi Ltd |
| JP 08033347 A | 02/02/1996 | Hitachi Ltd, et al. |
| JP 07222436 A | 08/18/1995 | Meidensha Corp |
| JP 05003678 A | 01/08/1993 | Toshiba F EE Syst KK, et al. |

III Non-Patent Literature Documents

Northern Arizona Wind & Sun; solar-electric.com; All about MPPT Solar Charge Controllers;
Nov. 05, 2007
SatCon Power Systems, PowerGate Photovoltaic 50 kW Power Converter System, June 2004
Bower, et al. Innovative PV Micro-Inverter Topology Eliminates Electrolytic Capacitors for
Longer Lifetime, 1-4244-0016-3/06 IEEE p. 2038
Gene Z. Guo, Design of a 400 W, 1Φ. Buck-Boost Inverter for PV Applications. 32. nd.
Annual Canadian Solar Energy Conference Jun. 10, 2007
Hua, C. et al., Control of DC/DC converters for solar energy system with maximum power
tracking, Department of Electrical Engineering; National Yumin University of Science &
Technology, Taiwan, Volume 2, Issue, 9-14 Nov. 1997 Page(s): 827-832
Kang, F. et al., Photovoltaic power interface circuit incorporated with a buck-boost converter
and a full-bridge inverter; doi:10.1016/j.apenergy.2004.10.009
Kretschmar K., et al. An AC converter with a small DC link capacitor for a 15 kW permanent
magnet synchronous integral motor, Power Electronics and Variable Speed Drives, 1998.
Seventh International Conference on (Conf. Publ. No. 456) Volume, Issue, 21-23 Sep. 1998
Page(s): 622-625
Lim, Y. H. et al., Simple maximum power point tracker for photovoltaic arrays, Electronics
Letters May 25, 2000 Vol. 36, No. 11
Matsuo, H. et al., Novel solar cell power supply system using the multiple-input DC-DC
converter, Telecommunications Energy Conference, 1998. INTELEC. Twentieth International,
Volume, Issue, 1998 Page(s): 797-8022
Román, E. et al. Intelligent PV Module for Grid-Connected PV Systems, IEEE Transactions of
Power Electronics, Vol. 53. No. 4 August 2006
Takahashi, I. et al. Development of a long-life three-phase flywheel UPS using an electrolytic
capacitorless converter/inverter, 1999 Scripta Technica, Electr. Eng. Jpn, 127(3): 25-32
Walker, G. R. et al, Cascaded DC-DC Converter Connection of Photovoltaic Modules, IEEE
Transactions of Power Electronics, Vol. 19. No. 4 July 2004
Walker, G. R. et al., “PV String Per-Module Power Point Enabling Converters,” School of
Information Technology and Electrical Engineering, The University of Queensland, presented
at the Australasian Universities Power Engineering Conference, AUPEC2003, Christchurch,
Sep. 28-Oct. 1, 2003.
Hashimoto, et al. A Novel High Performance Utility Interactive Photovoltaic Inverter System,
Department of Electrical Engineering, Tokyo Metropolitan University, 1-1 Minami-Osawa,
Hachioji, Tokyo, 192-0397, Japan, p. 2255
Shimizu, et al. Generation Control Circuit for Photovoltaic Modules, EII Transactions on
Power Electronics, Vol 16, No. 3, May 2001
Linear Technology, LTM4607 Specification Sheet
U.S. Provisional Application filed Oct. 15, 2007, Ser. No. 60/980,157
U.S. Provisional Application filed Oct. 23, 2007, Ser. No. 60/982,053
U.S. Provisional Application filed Nov. 15, 2007, Ser. No. 60/986,979
PCT Application filed Mar. 14, 2008, Serial Number PCT/US08/57105
PCT/US08/57105, filed 14 Mar. 2008
PCT/US08/60345, filed 10 Sep. 2008
PCT/US08/80606, filed 18 Jul. 2008

Thus, the applicant(s) should be understood to have support to claim and make a statement of invention to at least: i) each of the power circuits and devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-157. (canceled)

158. A solar power circuit comprising:
a first string power supply establishing a forward current direction, said first string power supply comprising a first voltage limiter established to limit voltage from said first string power supply;
a first string extrinsic power supply that is extrinsic to said first string power supply, said first string extrinsic power supply comprising a second voltage limiter established to limit voltage from said first string extrinsic power supply; and
a reverse current inhibitor established to inhibit reverse current through said first string power supply.

159. A solar power circuit as described in claim 158 further comprising a solar array of which said power circuit forms at least a part.

160. A solar power circuit as described in claim 158 wherein said first string extrinsic power supply comprises a second string power supply.

161. A solar power circuit as described in claim 158 wherein said first voltage limiter and said second voltage limiter each comprises a distinct DC/DC converter having voltage limiting capability.

162. A solar power circuit as described in claim 158 wherein said voltage limiters are each maximum operational output voltage limiters established to limit maximum operational voltage output from their corresponding power supply during normal operation.

163. A solar power circuit as described in claim 158 wherein said reverse current inhibitor comprises at least one reverse current preventer.

164. A solar power circuit as described in claim 158 wherein said reverse current inhibitor is a first reverse current inhibitor, and further comprising a second reverse current inhibitor established to inhibit reverse current through said first string extrinsic power supply.

165. A solar power circuit as described in claim 164 wherein said first reverse current inhibitor and said second reverse current inhibitor are connected to the same conductor, said same conductor inputting power to a DC/AC inverter.

166. A solar power circuit as described in claim 164 wherein said first reverse current inhibitor is a first diode and said second reverse current inhibitor is a second diode.

167. A solar power circuit as described in claim 164 wherein said first reverse current inhibitor is series connected with said first voltage limiter and said second reverse current inhibitor is series connected with said second voltage limiter.

168. A solar power circuit as described in claim 158 wherein said first string power supply comprises at least two primary power sources that are series connected.

169. A solar power circuit as described in claim 168 wherein each of said at least two primary power sources is a solar module.

170. A solar power circuit as described in claim 158 wherein said first string extrinsic power supply comprises at least two primary power sources, and wherein each of said at least two primary power sources is a solar module.

171. A solar power circuit as described in claim 158 wherein said first string extrinsic power supply comprises at least two power supplies that are series connected.

172. A solar power circuit as described in claim 158 wherein said reverse current inhibitor is a first reverse current inhibitor, and further comprising a second reverse current inhibitor, wherein said first string extrinsic power supply and said second reverse current inhibitor are connected in parallel with said first string power supply and said first reverse current inhibitor.

173. A solar power circuit as described in claim 172 further comprising at least one additional string power supply, at least one additional voltage limiter, and at least one additional reverse current inhibitor, wherein said additional componentry is connected in parallel with said first string power supply and said first reverse current inhibitor.

174. A solar power circuit as described in claim 158 further comprising an inverter established to convert DC power generated by said power supplies to AC power.

175. A solar power circuit as described in claim 158 wherein said power circuit comprises at least two power supply strings.

176. A solar power circuit as described in claim 175 further comprising a grounding portion, a negative output portion for each power supply string, a positive output portion for each power supply string, and at least two reverse current inhibitors for each power supply string.

177. A solar power circuit as described in claim 158 wherein said first string extrinsic power supply is connected in parallel with said first string power supply.
